(19) United States
(12) Patent Application Publication
(10) Pub. No.: US 2025/0355310 A1
(43) Pub. Date: Nov. 20, 2025

(54) OPTICAL WAVEGUIDE ELEMENT, AND OPTICAL TRANSMISSION APPARATUS AND OPTICAL MODULATION DEVICE USING OPTICAL WAVEGUIDE ELEMENT

(71) Applicant: SUMITOMO OSAKA CEMENT CO., LTD., Tokyo (JP)

(72) Inventors: Yu KATAOKA, Tokyo (JP); Norikazu MIYAZAKI, Tokyo (JP)

(73) Assignee: SUMITOMO OSAKA CEMENT CO., LTD., Tokyo (JP)

(21) Appl. No.: 18/291,861

(22) PCT Filed: Mar. 30, 2022
(86) PCT No.: PCT/JP2022/016319

§ 371 Date: Jan. 29, 2025

(51) Int. Cl. G02F 1/225; G02F 1/21

(52) U.S. Cl. CPC G02F 1/225; G02F 1/212

(57) ABSTRACT

An object of the present invention is to provide an optical waveguide element that can simplify wiring of an electrode and ensure a larger length of a working electrode portion.

An optical waveguide element according to the present invention includes a substrate 1 on which an optical waveguide 10 is formed; and an electrode that is disposed on the substrate and applies an electric field to the optical waveguide. The electrode includes a working electrode portion (BE1, BE10, or the like) that is disposed near the optical waveguide, a power supply portion (BT1, BT10, or the like) that supplies power to the electrode, and a wiring portion (BW1, BW10, or the like) that connects the working electrode portion and the power supply portion. A plurality of the working electrode portions are disposed at different positions on the substrate, and at least a part of the wiring portion is disposed to overlap at least a part of the working electrode portion or another wiring portion, with an insulating layer interposed between the part of the wiring portion and the part of the working electrode portion or another wiring portion.

### TECHNICAL FIELD

The present invention relates to an optical waveguide element, and an optical modulation device and an optical transmission apparatus using the optical waveguide element, and more particularly to an optical waveguide element including a substrate on which an optical waveguide is formed and an electrode that is disposed on the substrate and that applies an electric field to the optical waveguide.

### BACKGROUND ART

Optical waveguide elements, such as optical modulators, are widely used in an optical measurement technology field and in an optical communication technology field. In the optical waveguide element, an electrode is disposed on a substrate on which an optical waveguide is formed, and an electric field is applied to the optical waveguide using the electrode to change a phase of a light wave propagating through the optical waveguide. Hereinafter, an electrode portion for applying the electric field to the optical waveguide is referred to as a “working electrode portion”.

In recent years, it is necessary to miniaturize the optical waveguide element in order to reduce the mounting area of an optical modulation device. Therefore, the optical waveguide is folded and disposed as described in Patent Literature No. 1 or 2. FIG. 1 is a plan view showing an example of an optical waveguide element having a folded optical waveguide. In FIG. 1, four Mach-Zehnder-type optical waveguides are disposed in parallel, and the entire optical waveguide is significantly bent 180 degrees.

A region represented by a dotted line A in the optical waveguide is a modulation region in which an electric field corresponding to a modulation signal is applied to the optical waveguide by an electrode (not shown) and a modulation operation is performed. As shown in FIG. 1, in a portion of the optical waveguide separately from the modulation region, a bias electrode (BE1, BE10, or the like) is disposed to adjust a phase of a light wave passing through each Mach-Zehnder-type optical waveguide or the like.

In a case where a plurality of optical waveguides are disposed in parallel as shown in FIG. 1 and the bias electrode is provided for each optical waveguide, the length of the working electrode portion along the optical waveguide is shortened from the relationship of a wiring line for supplying power to the working electrode portion disposed close to the optical waveguide. Therefore, a DC bias voltage applied to the bias electrode is high, and a DC drift phenomenon is likely to occur.

Further, a pad portion for wire bonding is provided in an end portion of a chip in order to perform an electrical connection with the outside. In a case where the folded optical waveguide shown in FIG. 1 is used, the pad portions for supplying power to each bias electrode are disposed to be concentrated on one side of the chip. Therefore, wiring lines are more concentrated, and the length of the working electrode portion is shortened.

### CITATION LIST

### Patent Literature

[Patent Literature No. 1] Japanese Laid-open Patent Publication No. 2019-095698
[Patent Literature No. 2] Japanese Laid-open Patent Publication No. 2019-109442

### SUMMARY OF INVENTION

### Technical Problem

An object to be achieved by the present invention is to solve the above-described problems and to provide an optical waveguide element that can simplify wiring of an electrode and ensure a larger length of an electrode of a working electrode portion. In addition, the object of the present invention is to provide an optical modulation device and an optical transmission apparatus using the optical waveguide element.

### Solution to Problem

In order to achieve the object, an optical waveguide element, and an optical modulation device and an optical transmission apparatus using the optical waveguide element according to the present invention have the following technical features. (1) There is provided an optical waveguide element including: a substrate on which an optical waveguide is formed; and an electrode that is disposed on the substrate and applies an electric field to the optical waveguide. The electrode includes a working electrode portion that is disposed near the optical waveguide, a power supply portion that supplies power to the electrode, and a wiring portion that connects the working electrode portion and the power supply portion. A plurality of the working electrode portions are disposed at different positions on the substrate, and at least a part of the wiring portion is disposed to overlap at least a part of the working electrode portion or another wiring portion, with an insulating layer interposed between the part of the wiring portion and the part of the working electrode portion or another wiring portion.

(2) In the optical waveguide element according to (1), a first electrode layer, the insulating layer, and a second electrode layer may be disposed on the substrate to overlap one another, the working electrode portion may be formed in the first electrode layer, and at least a part of the wiring portion may be formed in the second electrode layer.

(3) In the optical waveguide element according to (1) or (2), a short-circuit wiring portion that electrically connects different working electrode portions may be provided, and the short-circuit wiring portion may be disposed to overlap at least a part of another working electrode portion, with an insulating layer interposed between the short-circuit wiring portion and the part of another working electrode portion.

(4) In the optical waveguide element according to (1) or (2), the insulating layer may be a film body that covers the optical waveguide and that has a lower refractive index than the optical waveguide.

(5) In the optical waveguide element according to (2), a buffer layer may be formed between the substrate and the first electrode layer.

(6) In the optical waveguide element according to any one of (1) to (5), the optical waveguide may have a structure portion in which a plurality of Mach-Zehnder-type optical waveguides are disposed in parallel, and at least a part of the wiring portion may be disposed to overlap at least a part of the Mach-Zehnder-type optical waveguide, with an insulating layer interposed between the part of the wiring portion and the part of the Mach-Zehnder-type optical waveguide.

(7) In the optical waveguide element according to any one of (1) to (6), at least a part of the wiring portion may have a portion that is in contact with the substrate or a buffer layer disposed on the substrate.

(8) In the optical waveguide element according to any one of (1) to (7), the electrode having at least a part of the wiring portion may be an electrode for applying a bias voltage.

(9) There is provided an optical modulation device including: the optical waveguide element according to any one of (1) to (8); a case that accommodates the optical waveguide element; and an optical fiber through which a light wave is input to the optical waveguide or is output from the optical waveguide.

(10) In the optical modulation device according to (9), the optical waveguide element may include a modulation electrode for modulating the light wave propagating through the optical waveguide, and an electronic circuit that amplifies a modulation signal to be input to the modulation electrode of the optical waveguide element may be provided inside the case.

(11) There is provided an optical transmission apparatus including: the optical modulation device according to (9) or (10); and an electronic circuit that outputs a modulation signal causing the optical modulation device to perform a modulation operation.

### Advantageous Effects of Invention

The present invention relates to an optical waveguide element including a substrate on which an optical waveguide is formed and an electrode that is disposed on the substrate and applies an electric field to the optical waveguide. The electrode includes a working electrode portion that is disposed near the optical waveguide, a power supply portion that supplies power to the electrode, and a wiring portion that connects the working electrode portion and the power supply portion. A plurality of the working electrode portions are disposed at different positions on the substrate, and at least a part of the wiring portion is disposed to overlap with at least a part of the working electrode portion or another wiring portion, with an insulating layer interposed between the part of the wiring portion and the part of the working electrode portion or another wiring portion. Therefore, the wiring portion can be disposed to be laid across the working electrode portion and another wiring portion, and it is possible to simplify wiring. As a result, it is also possible to set the length of an electrode, such as a bias electrode, to a larger value.

### BRIEF DESCRIPTION OF DRAWINGS

FIG. 1 is a plan view showing an optical waveguide element according to the related art.

FIG. 2 is a plan view showing a first example of an optical waveguide element according to the present invention.

FIG. 3 is a diagram showing a state of a cross section of a part of FIG. 2.

FIG. 4 is a diagram showing a state of a cross section of a part of FIG. 2 and showing an application example.

FIG. 5 is a diagram showing a state of a cross section of a part of FIG. 2 and showing another application example.

FIG. 6 is a plan view showing a second example of the optical waveguide element according to the present invention.

FIG. 7 is a plan view showing a third example of the optical waveguide element according to the present invention.

FIG. 8 is a plan view showing a fourth example of the optical waveguide element according to the present invention.

FIG. 9 is a plan view showing an optical modulation device and an optical transmission apparatus according to the present invention.

### DESCRIPTION OF EMBODIMENTS

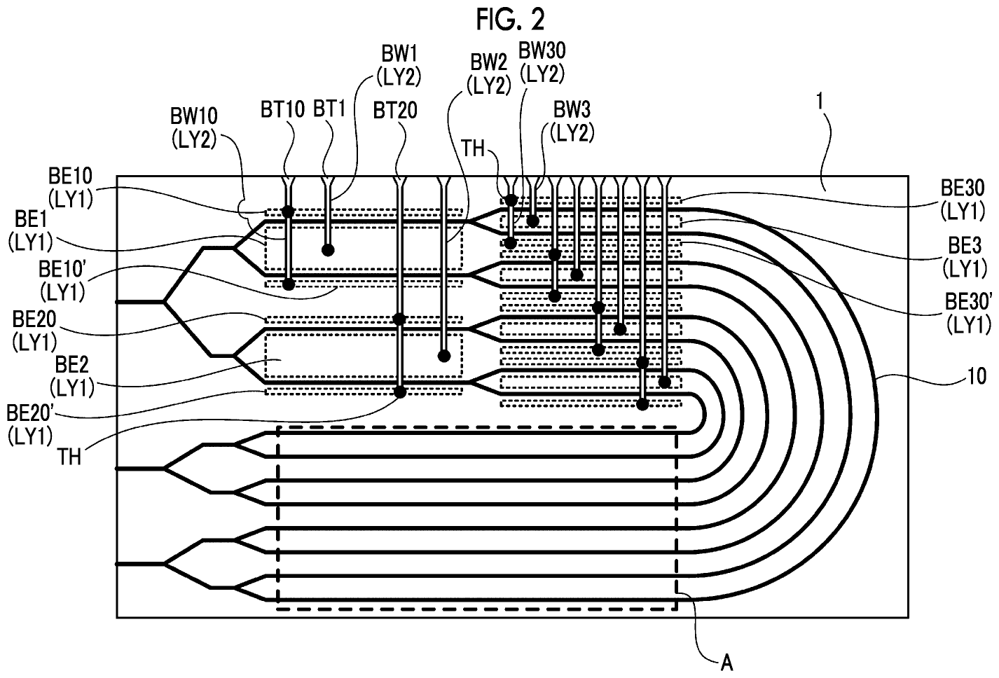

Hereinafter, an optical waveguide element according to the present invention will be described in detail with reference to preferred examples. As shown in FIGS. 2 to 8, the present invention relates to an optical waveguide element including a substrate 1 on which an optical waveguide 10 is formed and an electrode that is disposed on the substrate and applies an electric field to the optical waveguide. The electrode includes a working electrode portion (BE1, BE10, or the like) that is disposed near the optical waveguide, a power supply portion (BT1, BT10, or the like) that supplies power to the electrode, and a wiring portion (BW1, BW10, or the like)) that connects the working electrode portion and the power supply portion. A plurality of the working electrode portions that are disposed at different positions on the substrate are provided. At least a part of the wiring portion is disposed to overlap at least a part of the working electrode portion or another wiring portion, with an insulating layer (IN) interposed between the part of the wiring portion and the part of the working electrode portion or another wiring portion.

As the substrate used in the optical waveguide element according to the present invention, the following substrate can be used: a substrate made of a material having an electro-optic effect such as lithium niobate (LN), lithium tantalate (LT), lead lanthanum zirconate titanate (PLZT), or the like; or a substrate obtained by doping these substrate materials with magnesium. In addition, films and the like formed by vapor deposition using these materials can be used. Further, semiconductor substrate materials can also be used. Furthermore, in a case where a dielectric substrate made of LN or the like is used, as shown in FIG. 2 and the like, an X-cut substrate in which electrodes are disposed such that an optical waveguide is interposed between the electrodes or a Z-cut substrate in which an electrode is disposed on an optical waveguide is selected as appropriate.

It is also possible to set a thickness of the substrate 1, on which the optical waveguide is formed, to 10 μm or lower, more preferably 5 μm or lower, and still more preferably 1 μm or lower. For this thin substrate, a reinforcing substrate may be adhesively fixed to a lower side of the substrate 1 by direct joining or through an adhesive layer made of a resin or the like in order to increase mechanical strength. A substrate including an oxide layer made of a material, such as crystal or glass, that has a lower refractive index than the optical waveguide or the substrate, on which the optical waveguide is formed, and that has a similar coefficient of thermal expansion to the optical waveguide or the like is preferably used as the reinforcing substrate to be directly joined. A composite substrate obtained by forming a silicon oxide layer on a silicon substrate and a composite substrate obtained by forming a silicon oxide layer on a LN substrate, which are abbreviated to SOI and LNOI, respectively, can also be used.

For the “substrate on which the optical waveguide is formed” according to the present invention, both a substrate constituting an optical waveguide portion and a substrate integrated with the reinforcing substrate are collectively referred to as a “substrate”.

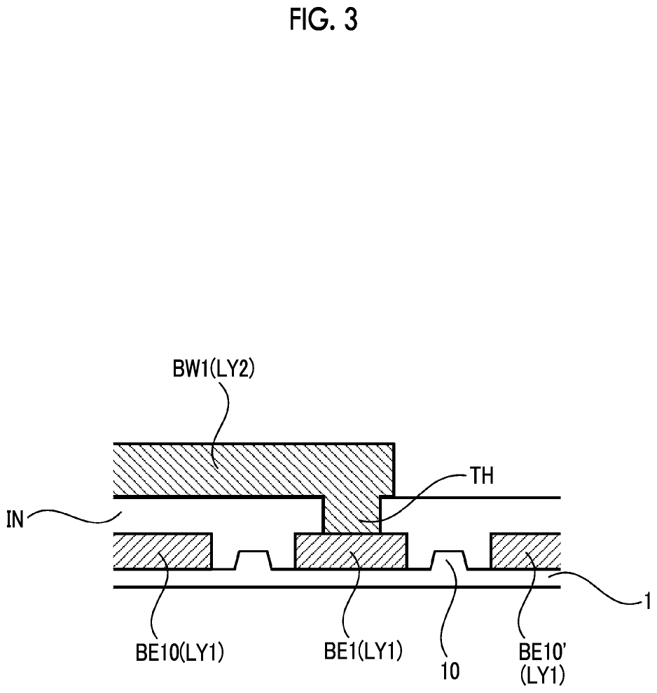

As a method for forming the optical waveguide 10, as shown in FIGS. 3 to 5, a rib-type optical waveguide obtained by, for example, etching the substrate 1 or forming grooves on both sides of the optical waveguide such that a portion corresponding to the optical waveguide has a protruding shape on the substrate can be used. In a case where the above-described thin substrate is used, a height of the rib-type optical waveguide is set to 4 μm or lower, more preferably 3 μm or lower, and still more preferably 1 μm or lower or 0.4 μm or lower. In addition, it is also possible to form a film on the reinforcing substrate with vapor deposition and to process the film to have a shape of the optical waveguide. In particular, in a case where a folded optical waveguide is used, an optical waveguide having a height and a width of 1 μm or lower is used.

Further, as another optical waveguide, a high-refractive-index portion can be formed on a surface of the substrate by a method for thermally diffusing Ti or the like on a substrate, a proton exchange method, or the like. In addition, Ti or the like can be thermally diffused in the rib-type optical waveguide to strengthen optical confinement.

Next, various buffer layers (protective films) will be described. It is possible to provide a resin film that covers the optical waveguide in order to suppress a propagation loss caused by roughness of a surface of the rib-type optical waveguide. The resin film includes a permanent resist film or the like. In addition, it is also possible to form a SiO₂ film on the optical waveguide in order to suppress absorption of light waves propagating through the optical waveguide by the electrode. The resin film or the SiO₂ film is a material having a lower refractive index than the optical waveguide. Furthermore, a film body made of Si, SiN, or the like may be formed on the substrate in order to suppress a pyroelectric effect of the substrate.

A first electrode layer which will be described below may be directly disposed on the substrate or may be disposed on the above-described buffer layer.

In the present invention, the resin film, the SiO₂ film, or the like can also be used as the insulating layer (IN) which will be described below. The insulating layer is disposed between the first electrode layer and a second electrode layer and serves to electrically separate the first electrode layer and the second electrode layer. However, these film bodies can also be formed at the same time as the process of forming the optical waveguide element in the related art or may be disposed by another additional process.

The electrode is formed on the substrate 1. Examples of the electrode include a modulation electrode including a signal electrode and a ground electrode and a bias electrode for applying a bias voltage. Metal with high conductivity, such as Au or Cu, is used as the electrode material. Various methods, such as a plating method, a vapor deposition method, and a sputtering method, can be adopted as the method for forming the electrode. An underlayer made of Ti, Nb, or the like can also be provided between the electrode and the substrate 1 or between the substrate and the Si film or the SiO₂ film disposed on the substrate to increase adhesive strength between the electrode and the substrate.

The present invention is characterized in that, as shown in FIGS. 2 to 8, the electrode includes the working electrode portion (see a reference numeral starting with BE) that is disposed near the optical waveguide, the power supply portion (see a reference numeral starting with BT) that supplies power to the electrode from the outside of the optical waveguide element, and the wiring portion (see a reference numeral starting with BW) that connects the working electrode portion and the power supply portion. The power supply portion is also a pad portion for power supply to which a wire, which is a power supply line, is bonded.

Then, in the present invention, at least a part of the wiring portion is disposed to overlap at least a part of another working electrode portion or another wiring portion, with the insulating layer (IN) interposed between the part of the wiring portion and the part of another working electrode portion or another wiring portion, and is configured to be laid across the working electrode portion or the wiring portion.

In order to achieve the configuration in which the wiring portion is laid across the working electrode portion or another wiring portion, the first electrode layer (LY1), the insulating layer (IN), and the second electrode layer (LY2) are disposed on the substrate 1 to overlap one another, the working electrode portion is formed in the first electrode layer, and at least a part of the wiring portion is formed in the second electrode layer. Of course, the present invention is not limited to the configuration including two electrode layers and one insulating layer interposed between the two electrode layers, and a configuration can also be used in which three or more electrode layers are provided and the insulating layer is disposed between the overlapping electrode layers.

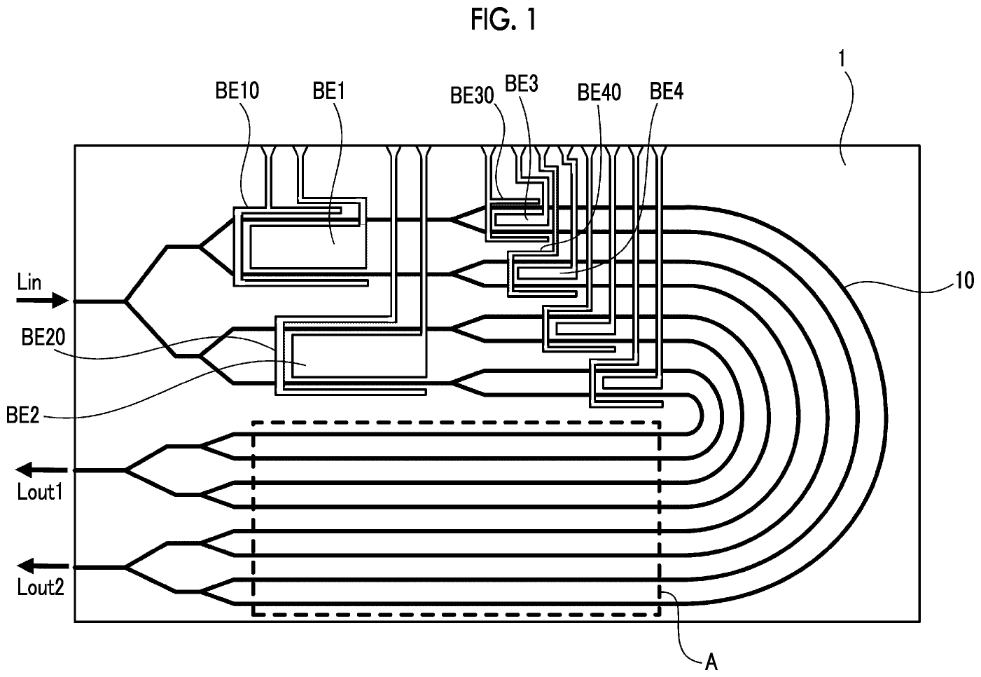

FIG. 2 is a plan view showing an aspect in which the present invention is applied to the substrate 1 on which the folded optical waveguide 10 is formed in the same manner as that in FIG. 1. A region represented by a dotted line A indicates a portion in which a modulation electrode is formed. The configuration according to the present invention is applied to the bias electrode, the working electrode portion (BE1, BE10, or the like) represented by a dotted line is formed in the first electrode layer (LY1), and the power supply portion (BT1, BT10, or the like) or the wiring portion (BW1, BW10, or the like) is formed in the second electrode layer (LY2). Then, the insulating layer (IN) (not shown) is disposed between the two electrode layers.

The wiring portion (BW1 or the like) and the working electrode portion (BE1 or the like) are connected by a conductive portion (through-hole) TH that penetrates the insulating layer. In a pedestal 2, a position where the through-hole is formed is represented by a black circle.

For the wiring portion (BW1) shown in FIG. 2, a cross-sectional view perpendicular to the drawing is shown in FIG. 3. In FIG. 3, the working electrode portions (BE1 and BE10, or BE1 and BE10′) are disposed such that the optical waveguide 10 is interposed between the working electrode portions. The wiring portion (BW1) is disposed above the working electrode portion, with the insulating layer IN interposed between the wiring portion and the working electrode portion. The wiring portion (BW1) and the working electrode portion (BE1) are electrically connected through the through-hole TH. Similarly, another wiring portion is disposed above the working electrode portion or the optical waveguide, with the insulating layer IN interposed therebetween, and is electrically connected to a specific working electrode portion by the through-hole TH.

As is clear from a comparison between FIG. 1 and FIG. 2, in the present invention, the position where the working electrode portion is disposed is not limited by a layout of the wiring portion of the electrode. Therefore, it is possible to sufficiently ensure the length of the working electrode portion along the optical waveguide. In addition, even in a case where a mounting area is minimized by miniaturization of a chip, it is possible to ensure the length of the working electrode portion that is equal to or higher than that in the related art.

In a case where the wiring portion is disposed across the optical waveguide, a material having a lower refractive index than the optical waveguide, for example, a resin or SiO₂, can be used for the insulating layer covering the optical waveguide. Therefore, it is also possible to suppress a problem in which the wiring portion absorbs the light waves propagating through the optical waveguide and a propagation loss occurs. In particular, in a case where the optical waveguide has a structure portion in which a plurality of Mach-Zehnder-type optical waveguides are disposed in parallel, the propagation loss of the Mach-Zehnder-type optical waveguide greatly affects the modulation performance of the optical waveguide element. Therefore, the role of the insulating layer is important.

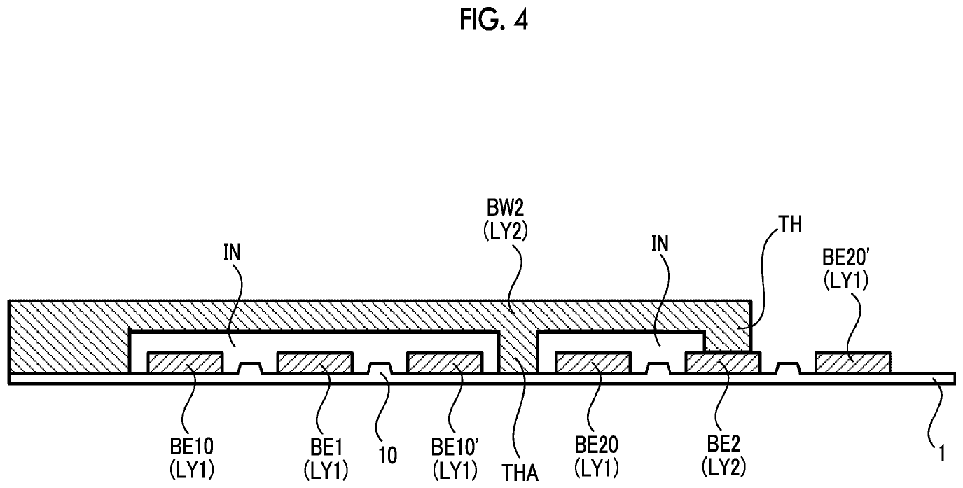

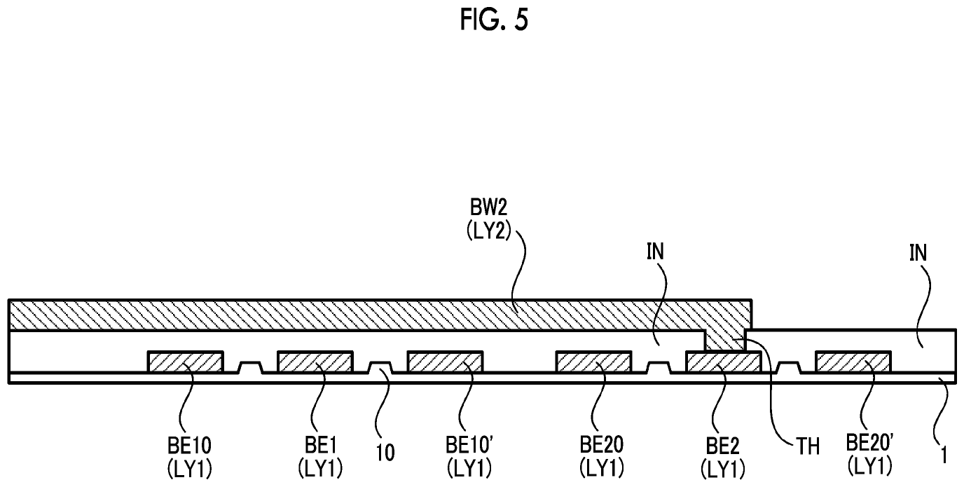

FIGS. 4 and 5 are cross-sectional views showing the wiring portion (BW2) shown in FIG. 2.

As shown in FIG. 4, the insulating layer (IN) can be provided only in a necessary portion below the wiring portion (BW2). In general, in a case where the electrode layer is disposed on the insulating layer, the adhesive strength between the insulating layer and the electrode layer is low. Therefore, there is a risk that the electrode layer will peel off. For this reason, in a portion in which the insulating layer is not required, the insulating layer is not disposed, and the first electrode layer and the second electrode layer are integrated. Alternatively, a through-hole (THA) obtained by providing a conductive portion in the through-hole formed in a portion of the insulating layer is formed, and the second electrode layer is bonded to the substrate 1 (or the buffer layer formed on the substrate 1). In this way, it is also possible to prevent the second electrode layer from peeling off.

In addition, as shown in FIG. 5, the insulating layer (IN) is widely disposed in a portion other than a necessary portion, which makes it possible to suppress problems such as scattering of propagating light due to the presence or absence of the insulating layer covering the optical waveguide and a propagation loss caused by a change in dielectric constant due to the presence or absence of the insulating layer between the electrodes.

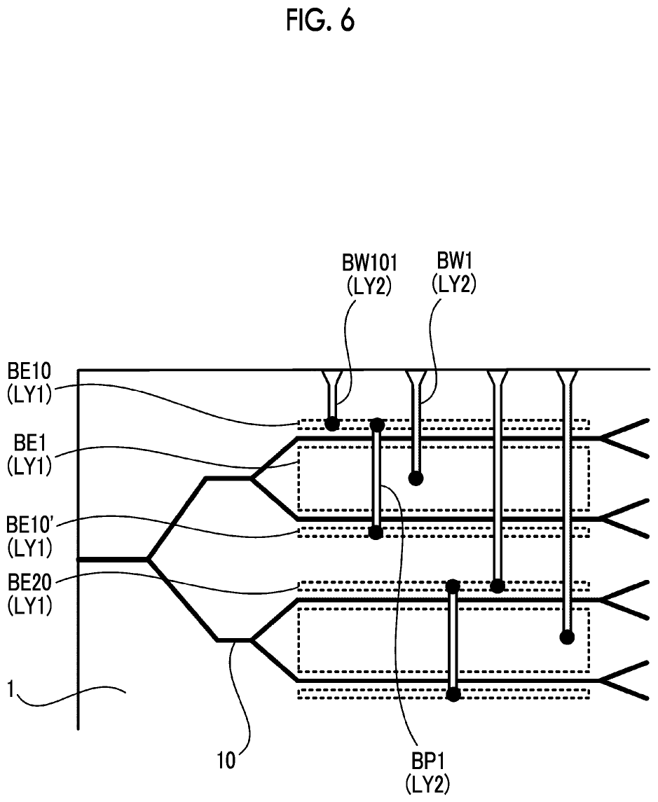

FIG. 6 shows a case where power is supplied to the working electrode portion not only by the wiring portion that extends from the power supply portion but also by a short-circuit wiring portion that electrically connects different working electrode portions. Specifically, the working electrode portion (BE10) is electrically connected to a wiring portion (BW101) extending from the power supply portion, and the working electrode portion (BE10) and the working electrode portion (BE10′) are electrically connected by a short-circuit wiring portion (BP1).

In order to prevent the short-circuit wiring portion (BP1) from being electrically connected to the working electrode portion (BE1), an insulating layer (not shown) is provided between the short-circuit wiring portion and at least a part of the working electrode portion (BE1) such that the short-circuit wiring portion and the part of the working electrode portion (BE1) are not directly connected to each other.

This configuration of the short-circuit wiring portion makes it possible to increase flexibility in the wiring of the electrode and to achieve more compact wiring. Further, since an additional short-circuit wiring portion is provided in addition to the wiring of the electrode shown in FIG. 2, it is possible to perform a more reliable electrical connection between different working electrode portions. In addition, since the working electrode portions are electrically connected at a plurality of positions, it is also possible to prevent the working electrode portion from functioning as an antenna against noise.

In FIG. 6, the short-circuit wiring portion (BP1) is formed in the second electrode layer (LY2). However, the short-circuit wiring portion (BP1) can be provided in the first electrode layer, can be disposed so as to bypass, for example, the working electrode portion (BE1), and can electrically connect the working electrode portions BE10 and BE10′. In addition, a short-circuit wiring portion that electrically connects the working electrode portions BE10′ and BE20 can also be provided in the first electrode layer. The short-circuit wiring portion is more useful to simplify a wiring structure as the number of working electrode portions connected at the same potential is larger.

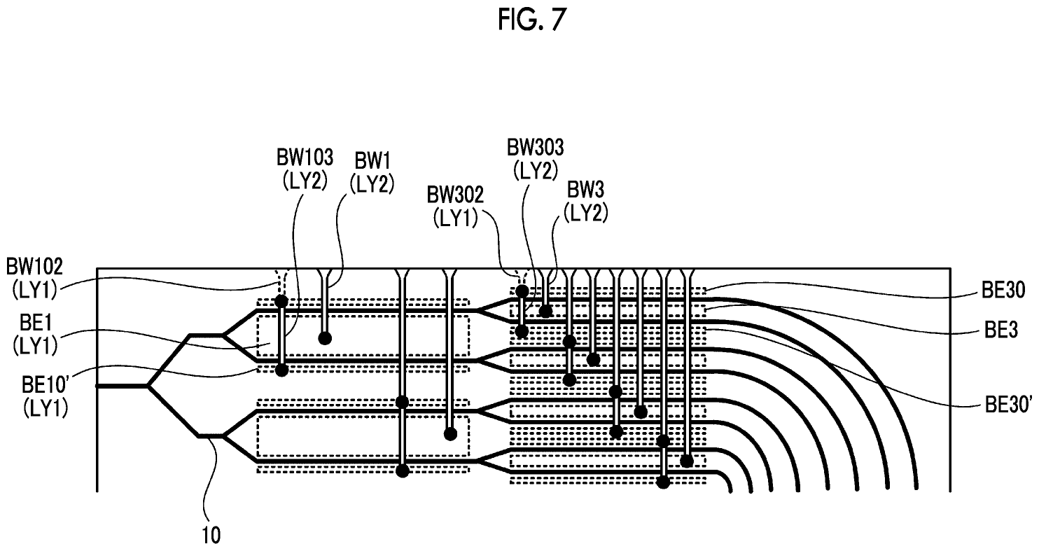

In FIG. 7, the power supply portion and the wiring portion (BW102 or BW302) connected to the power supply portion can also be formed in the first electrode layer, unlike other power supply portions and wiring portions. Further, in this case, for connection of the power supply line, such as wire bonding, it is necessary to avoid disposing the insulating layer on the power supply portion formed in the first electrode layer.

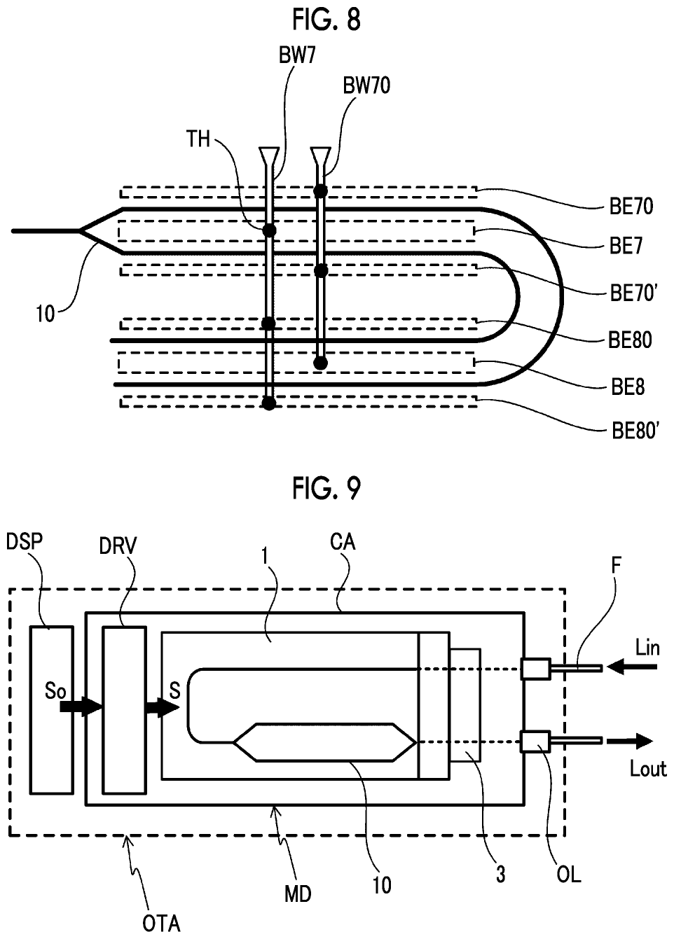

FIG. 8 shows a case where the same electric field is applied to the same optical waveguide before and after the folded optical waveguide, and wiring can be simply performed only by adjusting the positions of the through-holes TH for electrically connecting the wiring portions (BW7 and BW70) and the working electrode portions (BE7 to BE80′).

For the thicknesses of each electrode layer and the insulating layer used in the present invention, it is desirable that the thickness of each layer has the relationship of the first electrode layer<the insulating layer<the second electrode layer in order to prevent the pattern of each layer from being broken due to a level difference in a laminated portion and to ensure a sufficient withstand voltage between the electrode layers.

The first electrode layer forms an electrode that is disposed close to the optical waveguide or a modulation electrode by a high-frequency signal. Therefore, it is assumed that a manufacturing process having high manufacturing accuracy is used. In this process, it is difficult to form a thick photoresist or the like that is used for pattern formation. Therefore, it is desirable that the thickness is equal to or lower than 2 μm.

It is desirable that the thickness of the insulating layer is equal to or higher than 2 μm to compensate for the withstand voltage and to prevent the absorption of light by the second electrode layer.

Further, it is desirable that the second electrode layer is 1 μm or more thicker than the insulating layer in order to prevent disconnection in an etched portion (step portion) of the insulating layer.

As described above, as the electrode to which the present invention is applied, the bias electrode is more preferable than the modulation electrode through which a high-frequency signal propagates. In addition, in a case where the present invention is used for the modulation electrode, it is preferable to apply the configuration of the present invention to the wiring of the ground electrode rather than the signal electrode.

Further, the above description is focused on the formation of the input and output portions of the optical waveguide and a working portion (a region in which the working electrode portion is present) of the optical waveguide on the same substrate. However, the present invention is not limited to this configuration. For example, in FIG. 1, a substrate made of LN or the like may be used for a portion in which the working electrode portion is present, another different substrate, such as a Si substrate or a quartz substrate, may be formed for a branched waveguide portion of the Mach-Zehnder-type optical waveguide (the left side of the working electrode BE10) from input and output end portions or the folded optical waveguide, and the substrates may be connected to each other. In addition, the substrates on which the working electrode portions are present may be separately configured and then connected to each other. Further, a light source or the like may be connected to the substrate.

Next, examples in which the optical waveguide element according to the present invention is applied to an optical modulation device and an optical transmission apparatus will be described. FIG. 9 shows an optical waveguide element having the optical waveguide 10 obtained by folding one Mach-Zehnder-type optical waveguide. However, the present invention is not limited to the optical waveguide element, and an optical waveguide element having more Mach-Zehnder-type optical waveguides as shown in FIG. 2 or the like can also be used. Furthermore, it goes without saying that the present invention can be applied to a device for sensor and a high bandwidth-coherent driver modulator (HB-CDM).

As shown in FIG. 9, the optical waveguide element includes the optical waveguide 10 formed on the substrate 1 and a modulation electrode (not shown) for modulating light waves propagating through the optical waveguide 10 and is accommodated in a case CA. Furthermore, an optical modulation device MD can be configured by providing optical fibers (F) through which the light waves are input to the optical waveguide and are output from the optical waveguide. In FIG. 9, the optical fiber F is optically coupled to the optical waveguide 10 in the optical waveguide element using an optical block 3 including an optical lens, a lens barrel OL, and the like. The present invention is not limited to this configuration. The optical fiber may be introduced into the case through a through-hole that penetrates a side wall of the case. The optical fiber may be directly joined to an optical component or to the substrate, or the optical fiber having a lens function in an end portion of the optical fiber may be optically coupled to the optical waveguide in the optical waveguide element.

An optical transmission apparatus OTA can be configured by connecting, to the optical modulation device MD, an electronic circuit (digital signal processor DSP) that outputs a modulation signal So causing the optical modulation device MD to perform a modulation operation. It is necessary to amplify the modulation signal So output from the digital signal processor DSP in order to obtain a modulation signal S to be applied to the optical waveguide element. For this necessity, in FIG. 9, a driver circuit DRV is used to amplify the modulation signal. The driver circuit DRV and the digital signal processor DSP can also be disposed outside the case CA or can also be disposed inside the case CA. Particularly, the driver circuit DRV can be disposed inside the case to further reduce a propagation loss of the modulation signal from the driver circuit.

### INDUSTRIAL APPLICABILITY

As described above, according to the present invention, it is possible to provide an optical waveguide element that can simplify the wiring of an electrode and ensure a larger length of a working electrode portion. In addition, it is possible to provide an optical modulation device and an optical transmission apparatus using the optical waveguide element.

### REFERENCE SIGNS LIST

1: substrate (thin plate or film body) on which optical waveguide is formed
3: optical block
10: optical waveguide
BE1, BE10, BE10′: working electrode portion
BW1, BW10: wiring portion
BT1, BT10: power supply portion (pad portion)
BP1: short-circuit wiring portion
LY1: first electrode layer
LY2: second electrode layer
IN: insulating layer
F: optical fiber
OL: lens barrel
CA: case
MD: optical modulation device
DRV: driver circuit
DSP: digital signal processor
OTA: optical transmission apparatus

The invention claimed is:

1. An optical waveguide element comprising:
a substrate on which an optical waveguide is formed; and
an electrode that is disposed on the substrate and applies an electric field to the optical waveguide,
wherein the electrode includes a working electrode portion that is disposed near the optical waveguide, a power supply portion that supplies power to the electrode, and a wiring portion that connects the working electrode portion and the power supply portion,
a plurality of the working electrode portions are disposed at different positions on the substrate, and at least a part of the wiring portion is disposed to overlap at least a part of the working electrode portion or another wiring portion, with an insulating layer interposed between the part of the wiring portion and the part of the working electrode portion or another wiring portion.

2. The optical waveguide element according to claim 1, wherein a first electrode layer, the insulating layer, and a second electrode layer are disposed on the substrate to overlap one another, the working electrode portion is formed in the first electrode layer, and at least a part of the wiring portion is formed in the second electrode layer.

3. The optical waveguide element according to claim 1,
wherein a short-circuit wiring portion that electrically connects different working electrode portions is provided, and the short-circuit wiring portion is disposed to overlap at least a part of another working electrode portion, with an insulating layer interposed between the short-circuit wiring portion and the part of another working electrode portion.

4. The optical waveguide element according to claim 1,
wherein the insulating layer is a film body that covers the optical waveguide and that has a lower refractive index than the optical waveguide.

5. The optical waveguide element according to claim 2,
wherein a buffer layer is formed between the substrate and the first electrode layer.

6. The optical waveguide element according to claim 1, wherein the optical waveguide has a structure portion in which a plurality of Mach-Zehnder-type optical waveguides are disposed in parallel, and at least a part of the wiring portion is disposed to overlap at least a part of the Mach-Zehnder-type optical waveguide, with an insulating layer interposed between the part of the wiring portion and the part of the Mach-Zehnder-type optical waveguide.

7. The optical waveguide element according to claim 1, wherein at least a part of the wiring portion has a portion that is in contact with the substrate or a buffer layer disposed on the substrate.

8. The optical waveguide element according to claim 1, wherein the electrode having at least a part of the wiring portion is an electrode for applying a bias voltage.

9. An optical modulation device comprising:
the optical waveguide element according to any one of claims 1 to 8;
a case that accommodates the optical waveguide element; and
an optical fiber through which a light wave is input to the optical waveguide or is output from the optical waveguide.

10. The optical modulation device according to claim 9, wherein the optical waveguide element includes a modulation electrode for modulating the light wave propagating through the optical waveguide, and an electronic circuit that amplifies a modulation signal to be input to the modulation electrode of the optical waveguide element is provided inside the case.

11. An optical transmission apparatus comprising:
the optical modulation device according to claim 9; and
an electronic circuit that outputs a modulation signal causing the optical modulation device to perform a modulation operation.
